(19) United States
(12) Patent Application Publication
(10) Pub. No.: US 2016/0116940 A1
(43) Pub. Date: Apr. 28, 2016

(54) Band For A Wearable Device

(71) Applicant: Filip Technologies, Inc., New York, NY (US)

(72) Inventors: Gene Douglas Jones, Yacolt, WA (US); Kyle J. Waatti, Woodland, WA (US); Paal Selnaes, Morrisville, NC (US); Sten Kirkbak, Trondheim (NO); Dirk Ahlgrim, Boston, MA (US); Ari Adler, Cambridge, MA (US); Jonathan Peachey, New York, NY (US); Martin Hanssmann, Portsmouth, NH (US)

(21) Appl. No.: 14/522,237

(22) Filed: Oct. 23, 2014

(51) Int. Cl. G06F 1/16

(52) U.S. Cl. CPC G06F 1/163; G06F 1/1698

(57) ABSTRACT

This disclosure relates to bands for wearable devices. In an aspect, the band includes a support structure with an antenna disposed thereon. An electronics unit is coupled to the support structure. The band can include an opening that surrounds the support structure. The band can also include an electronics casing that surrounds the electronics unit. The band can be removed from the support structure and the electronics unit.

### BACKGROUND

Devices capable of wireless communication have become pervasive in society. “Smart” portable devices such as smartphones and tablet computers are nearly ubiquitous. These devices are typically able to connect to wireless networks using a variety of radiofrequency standards, such as Wi-Fi, cellular, and Bluetooth.

There have been attempts to develop wearable devices that can offer much of the utility of these smart devices in a package that can be worn on the body. Many wearable devices, however, are unable to strike a sufficient balance between comfort, flexibility, and support for the electronics that are necessary for such devices. Accordingly, there is a need in the art for a band for a wearable device that is flexible and comfortable, while retaining the structural integrity necessary to support the electronic components and antennas used with such a device.

### SUMMARY

It is to be understood that both the following general description and the following detailed description are exemplary and explanatory only and are not restrictive, as claimed. Provided is a band for a wearable device.

In one aspect, a band for a wearable device can include a support structure that has an antenna. The support structure can be coupled to an electronics unit. The band can include an opening that surrounds the support structure. The opening can run the length of the band. The band can also include an electronics casing that surrounds the electronics unit. The electronics casing can leave a screen on the electronics unit fully visible. The electronics casing can also be configured so as to not cover the bottom of the electronics unit. The band can be removed from the support structure and the electronics unit by removing the electronics casing from the electronics unit. The band can also be removed from the support structure by removing the support structure from the opening. The band can be made from an elastomer material. The wearable device can be worn on a wrist. The band can be a single unit.

In another aspect, a method for removing a band having an electronics casing from a wearable device that has a support structure and an electronics unit is described. The method can include lifting the electronics casing from the electronics unit, pulling the electronics casing over the electronics unit, and pulling the support structure out of the band. The step of lifting the electronics casing from the electronics unit can include the step of applying an upward pulling force toward an end opposite a junction between the support structure and the electronics unit. The step of lifting the electronics unit can also include applying a downward pulling force toward an end opposite a junction between the support structure and the electronics unit. The step of pulling the electronics casing over the electronics unit can also include the step of pulling the electronics casing toward a junction between the support structure and the electronics unit. The band can be a single unit.

In another aspect, a band for a wearable device is described. The wearable device can include a support structure that includes an antenna and an electronics unit that includes a screen coupled to the support structure. The support structure can be fastened to the electronics unit. The support structure can also be fused to the electronics unit. The band can be a single unit made from an elastomer material that includes an opening that surrounds the support structure and runs the length of the band. The band can include an electronics casing that surrounds the electronics unit and leaves the screen fully visible. The band can be removed from the support structure and the electronics unit. The band can be removed from the support structure by removing the electronics casing from the electronics unit. The band can also be removed from the support structure by removing the support structure from the opening. The wearable device can be worn on a wrist.

Additional advantages will be set forth in part in the description which follows or may be learned by practice. The advantages will be realized and attained by means of the elements and combinations particularly pointed out in the appended claims.

### BRIEF DESCRIPTION OF THE DRAWINGS

The accompanying drawings, which are incorporated in and constitute a part of this specification, illustrate embodiments and together with the description, serve to explain the principles of the apparatus:

FIG. 1 is a perspective view of a wearable device in accordance with an exemplary embodiment of the apparatus described herein;

FIG. 2 is a perspective view of a support structure for a wearable device separated from the band for a wearable device in accordance with an exemplary embodiment of the apparatus described herein;

FIG. 3 is a perspective view of a support structure for a wearable device in accordance with an exemplary embodiment of the apparatus described herein;

FIG. 4a is a perspective view of a band for a wearable device in accordance with an exemplary embodiment of the apparatus described herein;

FIG. 4b is a second perspective view of a band for a wearable device in accordance with an exemplary embodiment of the apparatus described herein;

FIG. 5 is a cutaway view of a band for a wearable device in accordance with an exemplary embodiment of the apparatus described herein;

FIG. 6 is a perspective view of a mold apparatus for a band for a wearable device in accordance with an exemplary embodiment of the apparatus described herein;

FIG. 7 is a perspective view of a mold apparatus for a band for a wearable device with the band in place in accordance with an exemplary embodiment of the apparatus described herein;

FIG. 8 is a perspective view of a mold apparatus for a band for a wearable device with the band removed in accordance with an exemplary embodiment of the apparatus described herein;

FIG. 9 is a flow chart describing a method of removing a band from a wearable device in accordance with an exemplary embodiment of the apparatus described herein; and

FIG. 10 is a flow chart describing a method of installing a band on a wearable device in accordance with an exemplary embodiment of the apparatus described herein.

### DETAILED DESCRIPTION

Before the present apparatus is disclosed and described, it is to be understood that the claimed apparatus is not limited to specific components, configurations, or to particular implementations described herein. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the distribution points of each of the ranges are significant both in relation to the other distribution point, and independently of the other distribution point.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to make the described apparatus. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all apparatuses. This applies to all aspects of this application.

The present apparatus may be understood more readily by reference to the following detailed description of preferred embodiments and the examples included therein and to the Figures and their previous and following description.

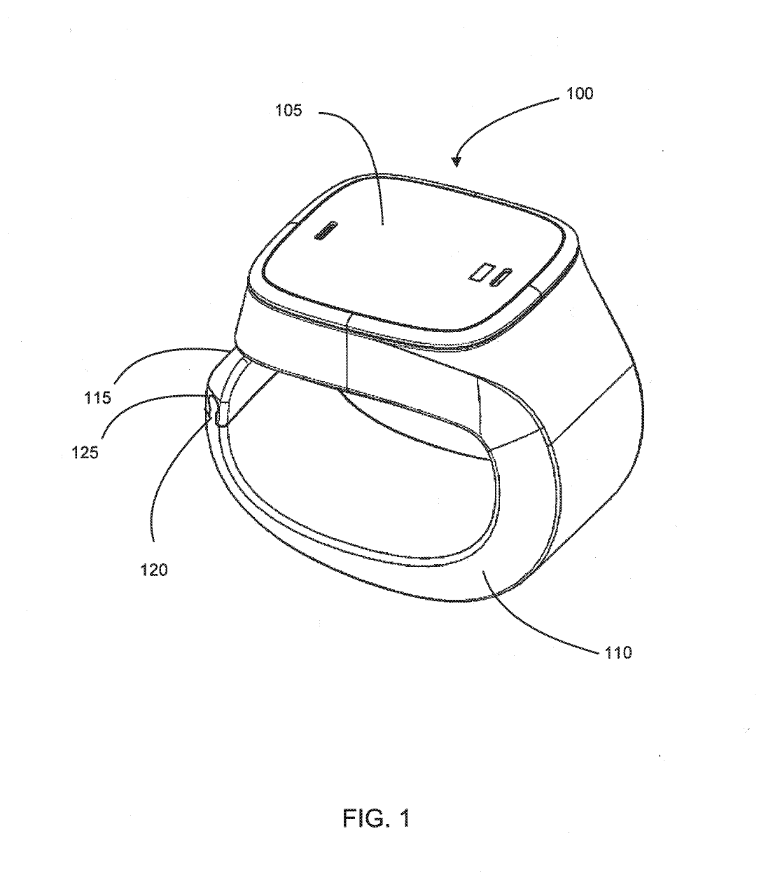

Turning now to FIG. 1, a perspective view of a wearable device in accordance with an exemplary embodiment of the apparatus is shown. In an exemplary embodiment, the wearable device 100 is a wrist-borne device. In alternative exemplary embodiments, the apparatus may be worn on other areas of the body, such as the ankle, waist, neck, or around other parts of the legs and/or torso. As one of skill in the art would understand, modifying the wearable device 100 to fit various parts of the body involves modifying the size and configuration of a band 110 so as to be the appropriate size and have the appropriate rigidity for a given application. Such modifications are within the scope of the present disclosure.

In an exemplary embodiment, the wearable device 100 includes an electronics unit 105. The exemplary electronics unit 105 can be a multi-functional device such as the device described in U.S. patent application Ser. No. 14/011352 and PCT Application Nos. PCT/US2013/020368 and PCT/US2013/020355, the disclosure of which are incorporated herein by reference. The wearable device can also include a band 110. The exemplary band 110 is made from an elastomer material, however, as one of skill in the art would understand, the band 110 can be made of any material with sufficient strength to be worn and sufficient flexibility to allow the band 110 to be used as described herein. In an exemplary embodiment, the band 110, once formed, is made from a single piece of material. In an alternative exemplary embodiment, the band 110 can be formed from multiple pieces of material that are fused together to form a single piece of material.

The exemplary wearable device 100 can also include a spacer 115 attached to the end of the band 110. In an exemplary embodiment, the band 110 has a protrusion 120 that has a mating receptacle 125 in the spacer 115. In an alternative exemplary embodiment, the spacer 115 can have a protrusion and the band can have a mating receptacle for receiving the protrusion from the spacer 115. One of skill in the art would understand that there are numerous methods for attaching the spacer 115 to the band 110, and that all such methods are within the scope and spirit of this disclosure.

The spacer 115 can be configured to perform multiple functions. In an exemplary embodiment, the spacer 115 attaches to the end of the band 110 but is sized so that the spacer 115 does not come into contact with the end of the device 100 that contains the electronics unit 105. In this embodiment, the spacer does not change the size of the opening created by the band 110. In an alternative exemplary embodiment, the spacer 115 is larger and engages with the band 110 that surrounds the electronics unit 105. In this embodiment, the spacer 115 can engage with the electronics unit 105 by way of, for example, magnets or a latch. This engagement can stretch the band 110 so as to create a larger opening. In this embodiment, the spacer 115 also provides a closed loop to further secure the device 100 in place.

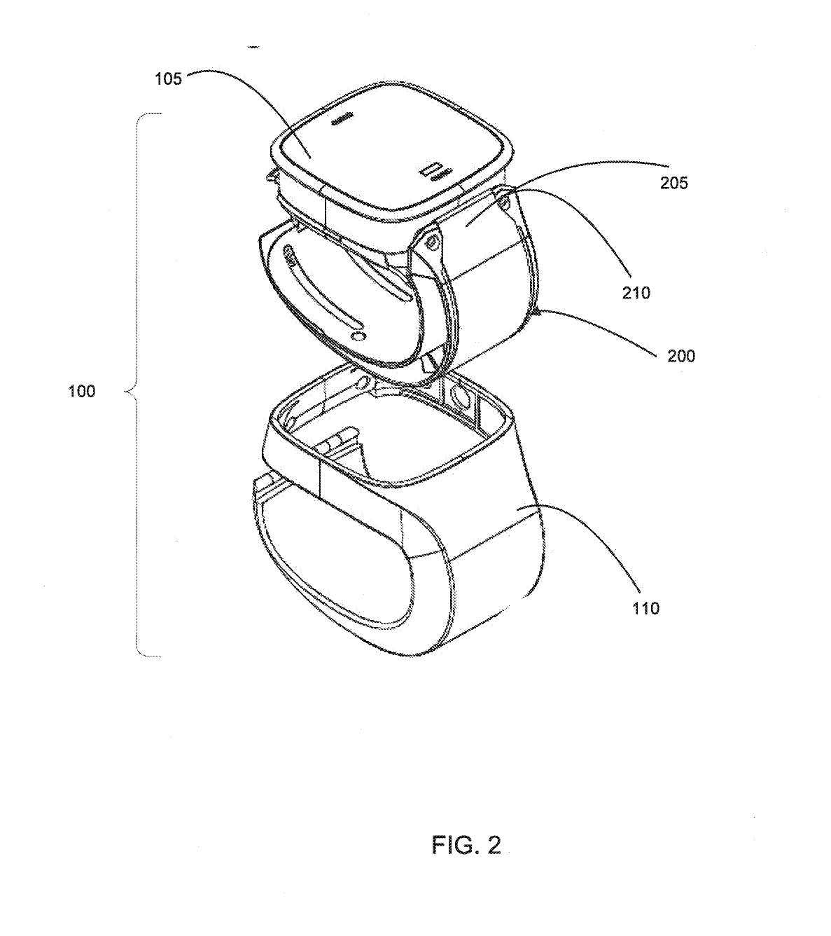

Turning now to FIG. 2 a support structure 200 for a wearable device separated from the band 110 for a wearable device is shown. In an exemplary embodiment, the support structure 200 provides structural support for the band 110. An exemplary embodiment of the support structure is described in U.S. patent application Ser. No. 14/479,219, the disclosure of which is incorporated herein by reference. The support structure 200 includes an antenna 210 disposed thereon. An exemplary embodiment of the antenna and support structure is described in U.S. patent application Ser. No. 14/011352, the disclosure of which is incorporated herein by reference.

The support structure 200 is coupled to the electronics unit 105. In an exemplary embodiment, the support structure 200 is coupled to the electronics unit 105 by fasteners such as screws, bolts, or rivets that pass through apertures 210. In an alternative exemplary embodiment, the support structure 200 can be fused or glued to the electronics unit 105 using techniques that would be known to a person of skill in the art. In either embodiment, once the support structure 200 is attached to the electronics unit 105, it forms a single unit of sufficient strength that the support structure 200 will not separate from the electronics unit 105 during normal use,

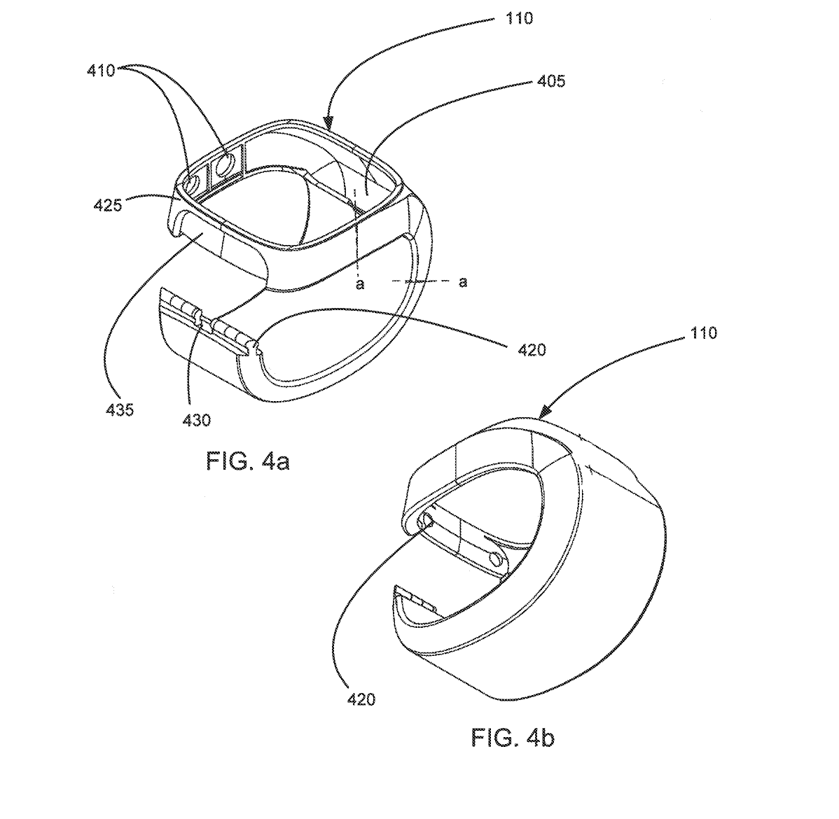

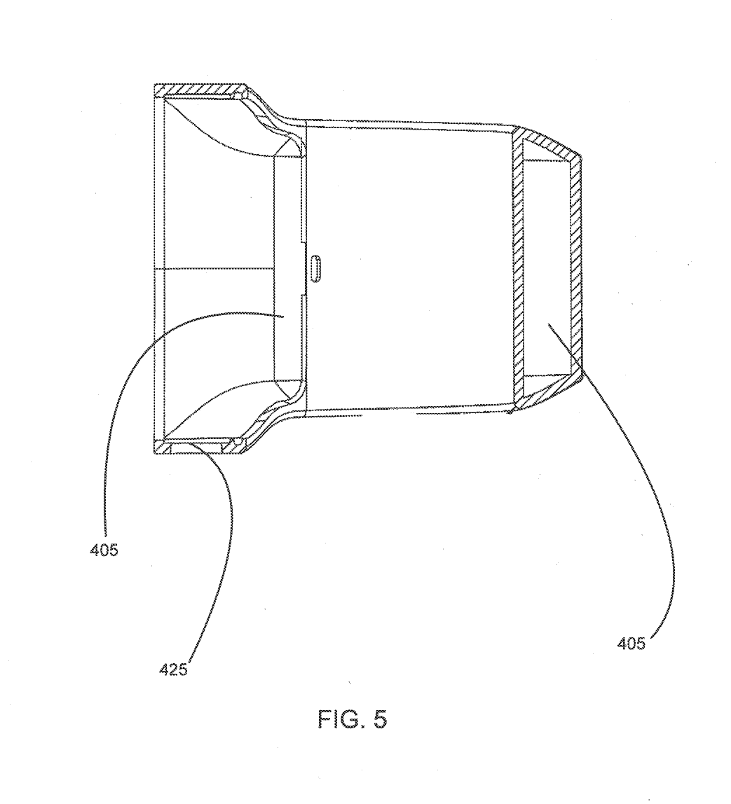

FIG. 2 also shows the band 110 separated from the rest of the device 100. FIG. 2 shows additional details of the band 110 which will be described in greater detail with respect to FIGS. 4 and 5, below.

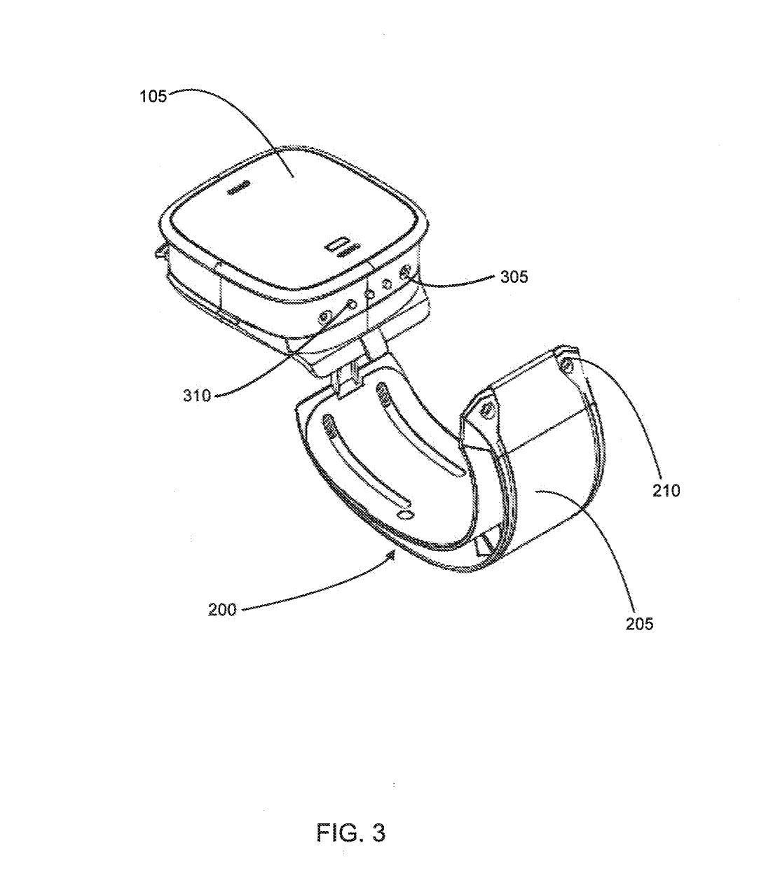

Turning now to FIG. 3, a support structure 200 for a wearable device 100 is shown. In particular, FIG. 3 provides a view of an exemplary embodiment of the support structure 200 before attachment to the electronics unit 105. The exemplary electronics unit 105 can include apertures 305 for receiving fasteners through apertures 210 on the support structure 200. The electronics unit can also include contacts 310. The exemplary contacts 310 are conductive members that contact conductive traces on the antenna 205 and pass signals between the antenna 205 and the electronics unit 105.

Turning now to FIGS. 4a and 4b, a band 110 for a wearable device in accordance with an exemplary embodiment of the apparatus described herein is shown. In an exemplary embodiment, the band 110 is hollow and includes an opening 405. The exemplary opening 405 runs the length of the band, and is configured to provide sufficient interior space to allow the support structure 200 (not shown in FIG. 4) to be inserted into the band 110. In the exemplary embodiment, the opening 405 extends through to opening 430, which allows a small portion of the support structure 200 to extend through and out of the band 110. In an exemplary embodiment, the portion of the support structure that extends through opening 430 is configured to substantially match the protrusions 420 of the band 110. In an alternative exemplary embodiment, opening 430 may be eliminated, and the support structure 200 can terminate within the opening 405 without protruding from the band 200.

The band 110 can also include an electronics casing 425. The exemplary electronics casing 425 is configured to surround the electronics unit 105 on the sides, but leave the top and the bottom exposed. The exemplary electronics casing 425 is also configured to include an opening at the top and bottom. In exemplary embodiment, the opening at the top of the electronics casing 425 is configured to allow a screen on the electronics unit 105 to be fully visible, with no material covering the screen. Likewise, the opening at the bottom of the electronics casing 425 is configured to leave the bottom of the electronics unit 105 exposed such that any connections, buttons, or other access points on the bottom of the electronics unit 105 are fully exposed and are not covered by band 110 material.

The band 110 can also include apertures 410 for buttons that protrude from the electronics unit 105. In an exemplary embodiment, there are two apertures allowing for two buttons on the electronics unit 105. In alternative exemplary embodiments more or fewer apertures 410 can be included. If the electronics unit 105 does not include buttons on the side, the apertures 410 can be eliminated. As one of ordinary skill in the art would understand, there are several ways the apertures 410 can be configured. In an exemplary embodiment, the apertures are openings without cover. In alternative exemplary embodiments, the apertures 410 can be raised areas in the band 110 that cover buttons on the electronics unit 105 while signaling the presence of the buttons and allowing them to be pressed from the outside.

The band 110 may also include protrusions 420 that allow accessories such as a spacer (115 in FIG. 1) to be attached to the end of the band 110. The attachment of a spacer to the band 110 is described in greater detail above with respect to FIG. 1.

The band 110 may also include an accessory engagement depression 435. The accessory engagement depression 435 configured to receive an accessory such as a spacer (115 in FIG. 1). In an exemplary embodiment, the accessory engagement depression 435 can also have magnet apertures 420 that can hold magnets that can be used to couple to corresponding magnets or metal in a spacer to help hold the spacer in place. In an alternative exemplary embodiment the engagement depression 435 can be replaced with a latch structure that can mate with a corresponding latch on the spacer.

The exemplary band 110 can be both installed and removed by a user of a device 100. The support structure 200 can be inserted into the opening 405 until the support structure 200 reaches the end of the opening 405. The electronics casing 425 can then be stretched around the electronics unit 105 and the band 110 will remain in place. In this way, the band can be changed, either to allow the user to change band color or style without replacing the entire unit, or to replace the unit without replacing the band 110.

Turning now to FIG. 5, a cutaway view of a band 100 for a wearable device in accordance with an exemplary embodiment of the apparatus described herein is shown. FIG. 5 shows a cutaway view cut along lines “a” in FIG. 4a. FIG. 5 shows additional detail of the opening 405, and shows the relative thickness of the walls in the band with respect to the opening in the exemplary embodiment. As one of skill in the art would understand, the thickness of the walls can vary depending on the desired outward appearance of the band and the size requirements of the support structure 200 and electronics unit 105.

The band 110 is advantageous in that it can be installed and replaced by the user. The band 110 is also advantageous because it is a single piece, and can be manufactured in a single molding step. This both reduces cost and makes a band that is stronger as compared to multi-piece bands.

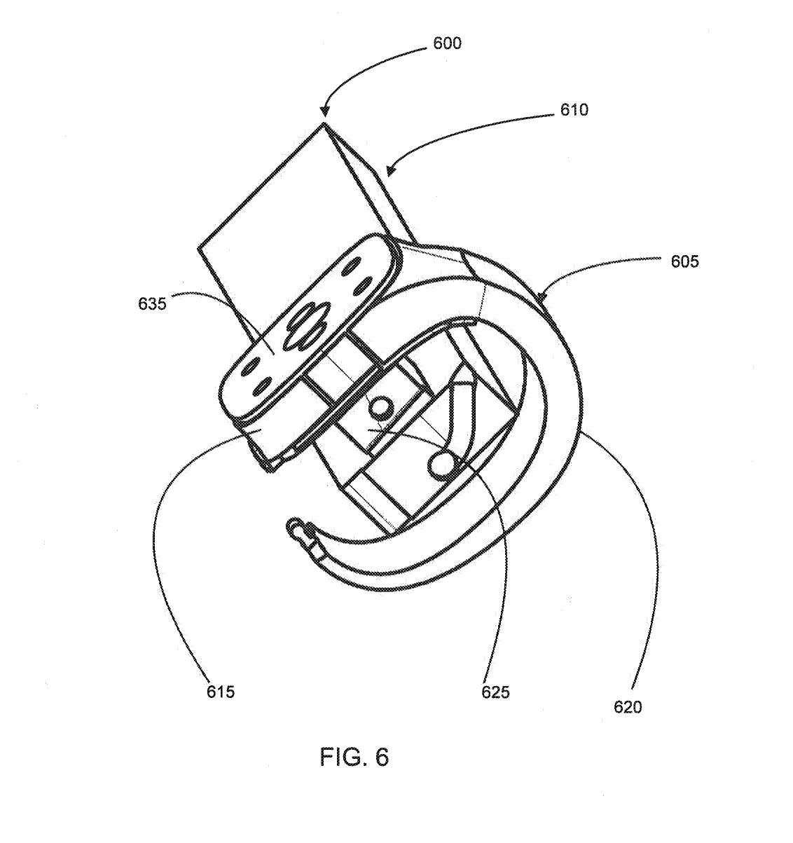

Turning now to FIG. 6, a mold apparatus 600 for a band 110 for a wearable device in accordance with an exemplary embodiment of the apparatus described herein is shown. The mold apparatus 600 provides the inner boundaries for the material used to form the band 110 during the molding process. The mold apparatus 600 includes a band mold 605 that forms the inner shape of the band. In an exemplary embodiment, the band mold 605 is substantially similar in size and shape to the support structure 200 (shown in FIG. 2). The mold apparatus 600 also includes a top portion 615. In an exemplary embodiment, the top portion 615 is substantially similar in size and shape to the electronics unit 105 (shown in FIG. 2). The mold apparatus also includes a mold insertion member 610 and a mold attachment member 625. The mold insertion member 610 holds the band mold 605 and the top portion 615 in place within a mold that will be closed around the mold apparatus 600. The mold insertion member 610 is coupled to the top portion 615 via the mold attachment member 625, which attaches to the bottom surface of the top portion 615. In an exemplary embodiment, the mold attachment member 625 forms a seal with the bottom of the top portion 615 that prevents material from forming at the junction, thus leaving the bottom open as shown in FIGS. 4a and 4b.

As one of skill in the art would understand, an outer mold is then closed around the mold apparatus 600. The outer mold (not shown) will form a cavity around the inner mold consistent with the desired shape of the band 110. In an exemplary embodiment, the outer mold attaches to the top surface 630 of the top portion 615 and the mold insertion member holds the band mold 605 and top portion 615 in place. In an exemplary embodiment, a material such as, but not limited to, an elastomer material is then injected into the mold, forming the band 110.

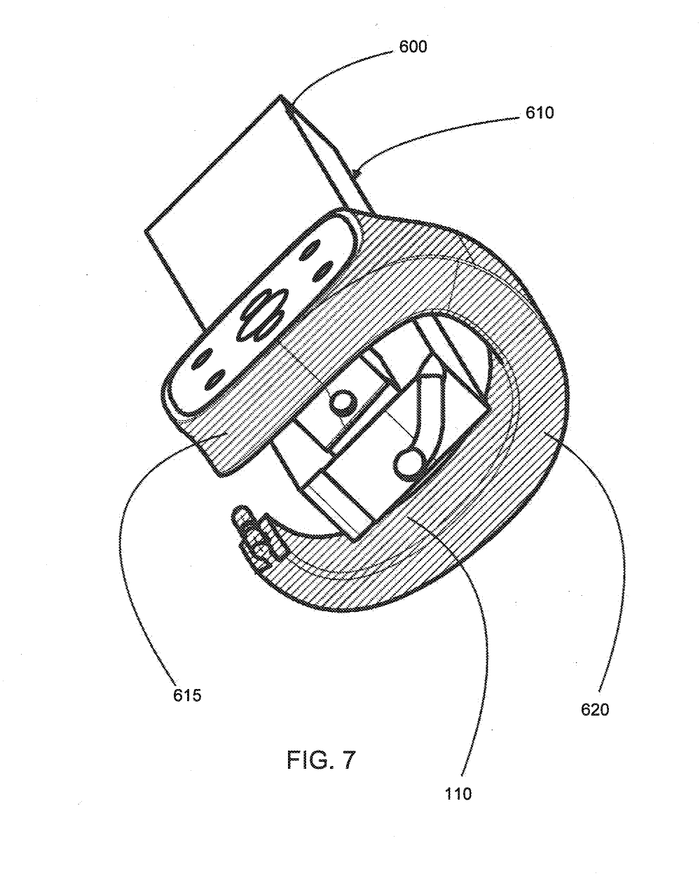

Turning to FIG. 7, a mold apparatus for a band 110 for a wearable device 100 with the band 110 in place is shown. FIG. 7 shows the band 110 (identified with shade lines) on the mold apparatus 600.

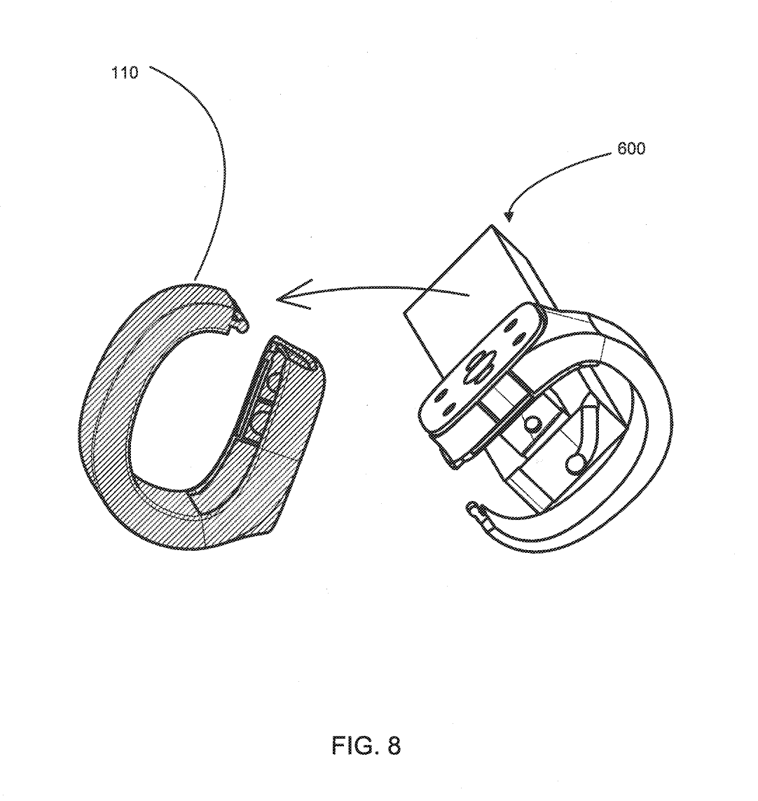

Turning to FIG. 8, a mold apparatus for a band 110 for a wearable device 100 with the band 110 removed is shown. The band 110 can be removed from the band mold 605 by peeling the electronics casing 425 back over the top surface and sliding the band 110 off of the mold apparatus 600.

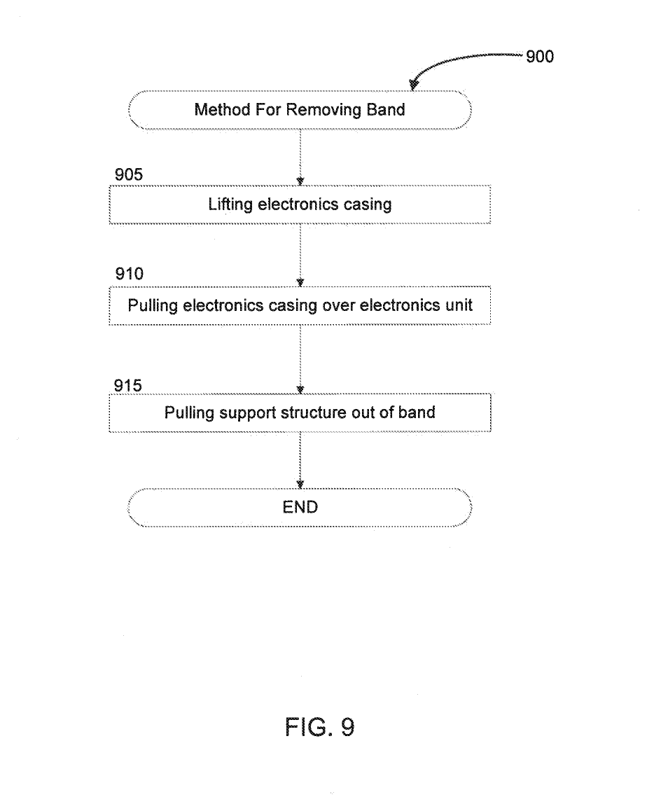

Turning to FIG. 9, a flow chart describing a method of removing a band 900 from a wearable device 100 in accordance with an exemplary embodiment of the apparatus described herein is shown. FIG. 9 will be discussed with respect to the device 100 as described with respect to FIGS. 1, 2, and 4. The method 900 begins with a device 100 configured essentially as shown in FIG. 1, wherein the band 110 is in place over the electronics unit 105 and support structure 200. The method 900 then proceeds to step 905, wherein the electronics casing 425 is lifted from the electronics unit 105. In an exemplary embodiment, the electronics casing 425 is pulled away from the electronics unit 105 by applying a pulling force toward the end opposite the junction between the support structure 200 and the electronics unit 105 and lifting the same upward toward the top of the electronics unit 105. In an alternative exemplary embodiment, the electronics casing 425 can be lifted from the electronics unit 105 by pulling the same end down, underneath the electronics unit 105.

The method 900 then proceeds to step 910, wherein the electronics casing 425 is pulled over the top of the electronics unit 105. In an exemplary embodiment, the electronics casing 425 is pulled toward the junction between the support structure 200 and the electronics unit 105.

The method 900 then proceeds to step 915, wherein the band 110 is pulled off of the support structure 200. This step separates the band 110 from the rest of the device 100. The method 900 then ends.

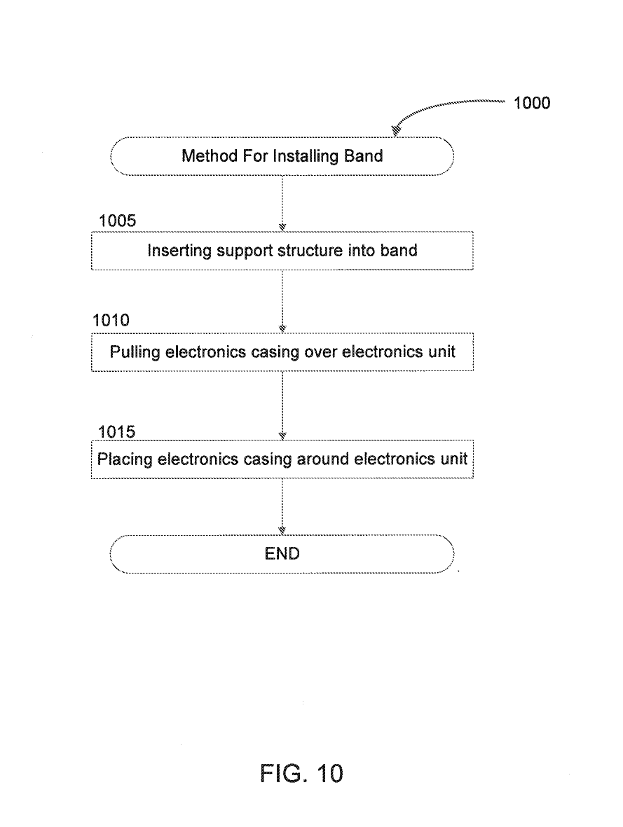

Turning now to FIG. 10, a flow chart describing a method 1000 of installing a band 110 on a wearable device 110 in accordance with an exemplary embodiment of the apparatus described herein is shown. The method 1000 of installing the band will be described with respect to FIGS. 1, 2, and 4. The installation of the band essentially is the reverse of the method for removing the band described with respect to FIG. 9, and begins with the band 110 separated from the rest of the device 100 as shown in FIG. 2. The method 100 starts at step 1005, wherein the support structure 200 is inserted into the opening 405 of the band 110. In an exemplary embodiment, the support structure 200 is inserted from beneath the electronics casing 425. In an alternative exemplary embodiment, the support structure 200 can be inserted through the opening in the electronics casing 425. The support structure 200 is slid into the opening 405 of the band 110 until it cannot move further without applying excessive force.

The method 1000 then proceeds to step 1010, wherein the electronics casing 425 is pulled over the electronics unit 105. In an exemplary embodiment, this can be accomplished by applying force to the portion of the electronics casing 425 that is opposite the opening 405 in the band 110.

The method 1000 then proceeds to step 1015, wherein the electronics casing 425 is placed around the electronics unit 105. In an exemplary embodiment, the electronics casing 425 is placed so that the device 100 appears substantially as shown in FIG. 1. The method 1000 then ends.

While the methods and apparatus have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A band for a wearable device, comprising:
a support structure comprising an antenna disposed thereon;
an electronics unit coupled to the support structure;
a band comprising an opening, the opening surrounding the support structure; and
the band further comprising an electronics casing, the electronics casing surrounding the electronics unit,
wherein the band is further configured to be removed from the support structure and the electronics unit.

2. The band of claim 1, wherein the band is removed from the support structure by removing the electronics casing from the electronics unit.

3. The band of claim 2, wherein the band is further removed from the support structure by removing the support structure from the opening.

4. The band of claim 1, wherein the band comprises an elastomer material.

5. The band of claim 1, wherein the opening runs the length of the band.

6. The band of claim 1, wherein the electronics casing leaves a screen on the electronics unit fully visible.

7. The band of claim 1, wherein the wearable device is configured to be worn on a wrist.

8. The band of claim 1, wherein the electronics casing does not cover the bottom of the electronics unit.

9. The band of claim 1, wherein the band comprises a single unit.

10. A method for removing a band comprising an electronics casing from a wearable device comprising a support structure and an electronics unit, comprising:
lifting the electronics casing from the electronics unit;
pulling the electronics casing over the electronics unit; and
pulling the support structure out of the band.

11. The method of claim 10, wherein the step of lifting the electronics casing from the electronics unit further comprises the step of applying an upward pulling force toward an end opposite a junction between the support structure and the electronics unit.

12. The method of claim 10, wherein the step of lifting the electronics casing from the electronics unit comprises applying a downward pulling force toward an end opposite a junction between the support structure and the electronics unit.

13. The method of claim 10, wherein the step of pulling the electronics casing over the electronics unit further comprises the step of pulling the electronics casing toward a junction between the support structure and the electronics unit.

14. The method of claim 10, wherein the band comprises a single unit.

15. A band for a wearable device, comprising:
a wearable device, comprising:
a support structure comprising an antenna disposed thereon; and
an electronics unit comprising a screen coupled to the support structure; and
a band comprising a single unit made from an elastomer material, the band further comprising:
an opening, the opening surrounding the support structure and running the length of the band; and
an electronics casing, the electronics casing surrounding the electronics unit and leaving the screen fully visible,
wherein the band is further configured to be removed from the support structure and the electronics unit.

16. The band of claim 15, wherein the band is removed from the support structure by removing the electronics casing from the electronics unit.

17. The band of claim 16, wherein the band is further removed from the support structure by removing the support structure from the opening.

18. The band of claim 15, wherein the wearable device is configured to be worn on a wrist.

19. The band of claim 5, wherein the support structure is fastened to the electronics unit.

20. The band of claim 15, wherein the support structure is fused to the electronics unit.
